(19) United States
(12) Patent Application Publication
(10) Pub. No.: US 2007/0237054 A1
(43) Pub. Date: Oct. 11, 2007

(54) Aberration correcting device, program thereof and disc apparatus equipped with the device

(75) Inventors: Tsuyoshi Eiza, Osaka (JP); Tetsuya Shihara, Osaka (JP); Shinya Shimizu, Osaka (JP); Kenji Nagashima, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/730,975

(22) Filed: Apr. 5, 2007

(30) Foreign Application Priority Data
Apr. 7, 2006 (JP) 2006-106771

(51) Int. Cl. G11B 7/00

(52) U.S. Cl. 369/112.02

(57) ABSTRACT

In disc discrimination operation of aberration correcting device including: light sources corresponding to n types (n is natural number, ≧2) of discs; and liquid crystal element having plurality of phase variation region (PVR) for correcting spherical aberration (CSA), total sum of maximum value (Max) among absolute values of variations from initial drive voltages (DVs) of applied DVs to DVs for CSA of first light beam in predetermined order for each of PVRs, and Max among absolute values of variations from DVs for CSA of k-th light beam to DVs for that of (k+1)th light beam, voltages being applied in predetermined order for each of PVRs when k (k is natural number that satisfies n−1≧k≧1) is changed from 1 to n−1, is minimum value among total sums determined in the same manner for every order of emitting light from light sources.

This application is based on Japanese Patent Application No. 2006-106771 filed on Apr. 7, 2006, the contents of which are hereby incorporated by reference.

### BACKGROUND OF THE INVENTION

1. Field of the Invention

The present invention relates to an aberration correcting device, a program thereof and a disc apparatus equipped with the device.

2. Description of Related Art

Recently, discs such as a CD and a DVD have become commonplace and widely available. Furthermore, in order to increase a quantity of information recorded on the disc, researches on the high density of the disc have been carried on. As a result, a high density discs such as an HD-DVD that is a high definition DVD and a Blu-Ray Disc (hereinafter referred to as a BD) are being available in the market, for example.

When such a disc is read or written, an optical pickup is used that projects a light beam onto the disc so that information can be recorded or reproduced. A numerical aperture (NA) of an objective lens and a wavelength of a light source that are used for the optical pickup have different values in accordance with a type of the disc. For example, an objective lens having an NA of 0.50 and a light source having a wavelength of 780 nm are used for a CD, an objective lens having an NA of 0.65 and a light source having a wavelength of 650 nm are used for a DVD, an objective lens having an NA of 0.65 and a light source having a wavelength of 405 nm are used for an HD-DVD, and an objective lens having an NA of 0.85 and a light source having a wavelength of 405 nm are used for a BD.

Since an NA of an objective lens and a wavelength have different values in accordance with a type of the disc in this way, it is considered to use different optical pickups for different discs. However, it is more convenient to use a single optical pickup that can reproduce and record information on a plurality of types of discs. Many of such optical pickups are already developed. For example, as described in JP-A-2005-317120, there is an optical pickup that can write and read information on a plurality of types of discs with a single objective lens.

In the case where a single objective lens supports a plurality of types of discs, there will be a problem of generation of spherical aberration. Therefore, a liquid crystal element is disposed in an optical path of the optical pickup, and a drive voltage of the liquid crystal element is controlled in accordance with a type of the disc so that spherical aberration can be corrected. A disc apparatus equipped with the optical pickup having the above mentioned liquid crystal element performs disc discrimination for determining a type of the loaded disc prior to reproducing or recording information. For this purpose, light sources corresponding to types of the disc are activated to emit light one by one, and in synchronization with it the drive voltage of the liquid crystal element is switched while a signal based on reflection light from the disc is detected. Since the liquid crystal element has a delay of response, there is a problem that a variation of the drive voltage may increase depending on the order of switching the drive voltage of the liquid crystal element resulting in long response time of the liquid crystal element, which may cause long operating time of the disc discrimination operation.

### SUMMARY OF THE INVENTION

In view of the above described problem it is an object of the present invention to provide an aberration correcting device that is capable of shortening operating time of the disc discrimination operation, a program thereof and a disc apparatus equipped with the device.

To attain the above described object an aberration correcting device in accordance one aspect of the present invention includes: light sources corresponding to n types (n is a natural number of two or more) of discs; a light source drive unit that drives the light sources; a liquid crystal element having a plurality of phase variations regions for correcting spherical aberration; a liquid crystal driver that drives the liquid crystal element; an objective lens that condenses a light beam; and a control unit that applies drive voltages to the phase variation regions sequentially, the drive voltages being for correcting spherical aberration of light beams emitted from the light sources sequentially, by using the light source drive unit and the liquid crystal driver in accordance with phase correction characteristics corresponding to the discs. The aberration correcting device is characterized by a structure in which in a disc discrimination operation of the aberration correcting device, a total sum of; a maximum value among absolute values of variations from initial drive voltages of the applied drive voltages to drive voltages for correcting spherical aberration of a first light beam in a predetermined order for each of the phase variation regions; and a maximum value among absolute values of variations from drive voltages for correcting spherical aberration of a k-th light beam to drive voltages for correcting spherical aberration of (k+1)th light beam, the voltages being applied in the predetermined order for each of the phase variation regions when k (k is a natural number that satisfies n−1≧k≧1) is changed from 1 to n−1 in turn, is a minimum value among the total sums that are determined in the same manner for every order of emitting light from the light sources.

According to the structure described above, response time of the liquid crystal element can be shortened, so that operating time of the disc discrimination operation can be shortened.

An aberration correcting device in accordance second aspect of the present invention is characterized by a structure with the above described first structure in which each of the drive voltages for correcting spherical aberration of the first light beam is a drive voltages having a minimum absolute value of variation from the initial drive voltage among a plurality of drive voltages for correcting the spherical aberration that exist because of periodicity of the light beam, and each of the drive voltages for correcting spherical aberration of the (k+1)th light beam is a drive voltages having a minimum absolute value of variation from the k-th drive voltage among the plurality of drive voltages.

According to the structure described above, response time of the liquid crystal element can be shortened much more, so that operating time of the disc discrimination operation can be shortened much more.

According to the aberration correcting device of the present invention, operating time of the disc discrimination operation can be shortened.

### BRIEF DESCRIPTION OF THE DRAWINGS

FIG. 1 is a block diagram of a disc reproducing apparatus according to the present invention.

FIG. 2 is a flowchart to show an operating procedure of a disc discrimination operation.

FIG. 3 is a flowchart to show a method for determining an order of discs.

FIG. 4 is a diagram to show phase variation for correcting spherical aberration for each of phase variation regions.

FIG. 5 is a flowchart to show another method for determining an order of discs.

### DETAILED DESCRIPTION OF THE PREFERRED EMBODIMENTS

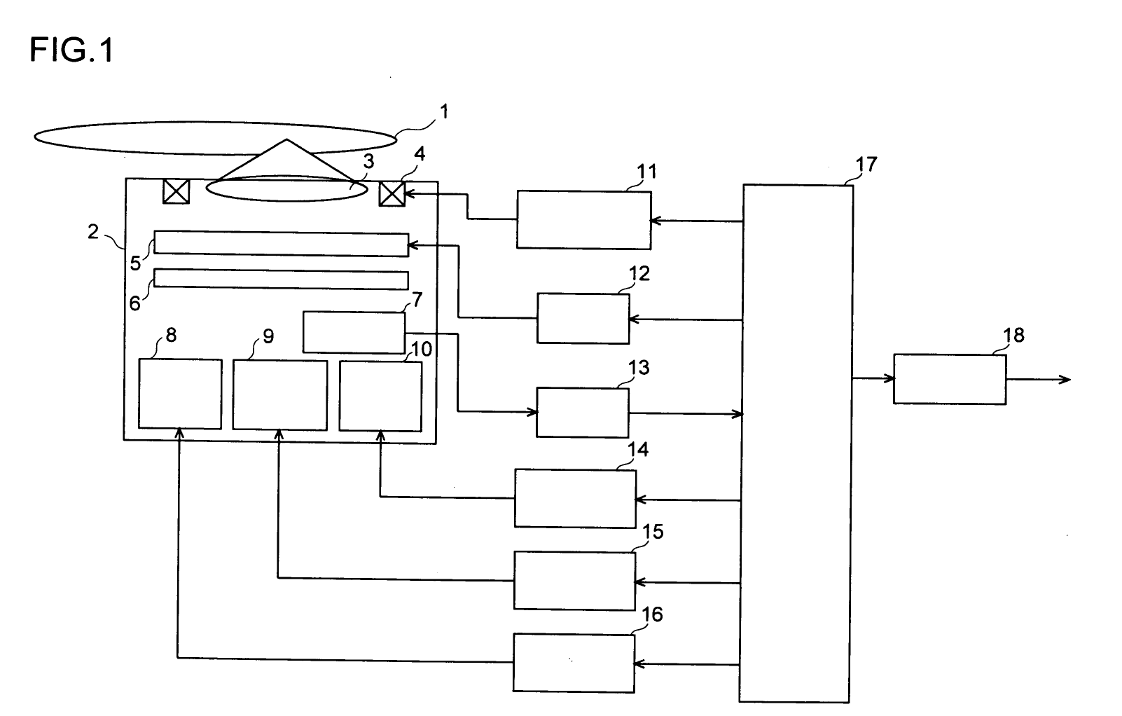

Hereinafter, embodiments of the present invention will be described with reference to the attached drawings. FIG. 1 is a block diagram of a disc reproducing apparatus as an example of a disc apparatus of the present invention.

An optical pickup 2 includes an objective lens 3, an actuator 4, a liquid crystal element 5, an aperture 6, a light receiving portion 7, a laser diode (LD) for a CD 8, an LD for a DVD 9 and an LD for a BD 10.

The LD for a CD 8 emits a laser beam having a wavelength of 780 nm for a CD. The LD for a DVD 9 emits a laser beam having a wavelength of 650 nm for a DVD. The LD for a BD 10 emits a laser beam having a wavelength of 405 nm for a BD.

The aperture 6 is an element for restricting an aperture in accordance with a wavelength of incident light, and it restricts the aperture for the laser beams emitted from the LD for a CD 8 and the LD for a DVD 9 so as to lead the laser beams to the liquid crystal element 5. In addition, the aperture 6 permits the laser beam emitted from the LD for a BD 10 to pass through without restriction and leads it to the liquid crystal element 5.

The liquid crystal element 5 includes a two transparent electrodes and liquid crystal sandwiched between these electrodes. Each of the electrodes may be made up of a plurality of concentric circular split areas. Alternatively, one of the electrodes may be made up of a plurality of concentric circular split areas, while the other electrode may be a common electrode that is not divided. According to such an electrode pattern, the liquid crystal element 5 has a plurality of phase variations regions, and a drive voltage is applied to each of the phase variation regions so that a phase of light entering each of the phase variation regions is changed before being emitted from each of the phase variation regions.

The laser beam that was emitted from the LD for a BD 10 and passed through the aperture 6 enters every phase variation region of the liquid crystal element 5, and its phase is changed before it enters the objective lens 3. In addition, the laser beam that was emitted from the LD for a DVD 9 and was restricted by the aperture 6 enters the phase variation region of the liquid crystal element 5 in the range inside and narrower than the range in which the above mentioned laser beam for a BD enters, and its phase is changed before it enters the objective lens 3. In addition, the laser beam that was emitted from the LD for a CD 8 and was restricted by the aperture 6 enters the phase variation region of the liquid crystal element 5 in the range inside and further narrower than the range in which the above mentioned laser beam for a DVD enters, and its phase is changed before it enters the objective lens 3.

The objective lens 3 condenses the laser beam from the liquid crystal element 5 onto the disc 1. Then, the laser beam after reflected by the disc 1 passes through the objective lens 3, the liquid crystal element 5 and the aperture 6, and it is received by the light receiving portion 7.

The light receiving portion 7 converts the received laser beam into an electric current signal, which is sent to an RF amplifier 13. The RF amplifier 13 generates a focus error signal, a tracking error signal and a total light quantity signal based on the current signal from the light receiving portion 7 and sends the generated signals to a control portion 17.

The control portion 17 generates a focus drive signal and a tracking drive signal based on the focus error signal and the tracking error signal and sends the generated signals to the actuator driver 11. The actuator driver 11 drives the actuator 4 of the optical pickup 2 based on the focus drive signal and the tracking drive signal. When the actuator 4 works, the objective lens 3 moves in the focus direction and in the tracking direction.

In addition, the control portion 17 sends a control signal to a liquid crystal driver 12, so that the liquid crystal driver 12 applies drive voltages to the liquid crystal element 5 based on the control signal. Furthermore, the control portion 17 send control signals to the LD driver for a BD 14, the LD driver for a DVD 15 and the LD driver for a CD 16, so that the LD driver for a BD 14, the LD driver for a DVD 15 and the LD driver for a CD 16 respectively drive the LD for a BD 10, the LD for a DVD 9 and the LD for a CD 8 based on the control signal.

In addition, the control portion 17 converts the total light quantity signal into a digital signal, and a demodulation process and an error correction process in accordance with a type of the disc are performed on the digital signal, which is then supplied to a reproduction process portion 18. The reproduction process portion 18 performs a decoding process on the digital signal from the control portion 17 in accordance with a type of the disc, so that the reproduced information is delivered.

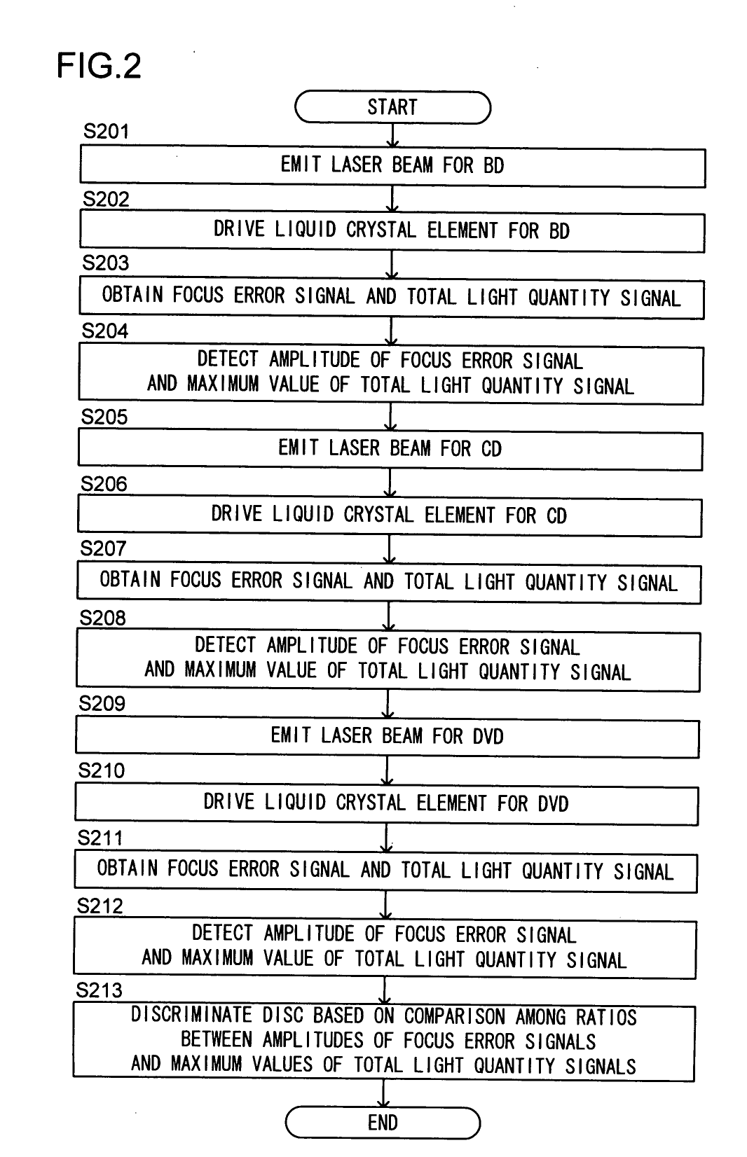

Next, a disc discrimination operation of the disc reproducing apparatus having the above mentioned structure according to the present invention will be described with reference to the flowchart shown in FIG. 2. Note that this disc discrimination operation is performed by the control portion 17 that executes a program stored in a memory (not shown).

At this point, it is supposed that an initial drive voltage of 0 V is applied to each of the phase variation regions of the liquid crystal element 5. First in the step S201 the control portion 17 sends a control signal to the LD driver for a BD 14, and the LD driver for a BD 14 drives the LD for a BD 10. Then, the LD for a BD 10 emits the laser beam.

Next, in the step S202 the control portion 17 sends a control signal to the liquid crystal driver 12, and the liquid crystal driver 12 applies a predetermined drive voltage for a BD to each of the phase variation regions of the liquid crystal element 5. Thus, spherical aberration is corrected for the laser beam that is emitted from the LD for a BD 10, passes through the aperture 6 and the liquid crystal element 5, and is condensed by the objective lens 3.

Then, in the step S203 the control portion 17 sends the focus drive signal to the actuator driver 11 so that the objective lens 3 moves in the direction of approaching the disc 1. On this occasion, the control portion 17 obtains the focus error signal and the total light quantity signal that are generated by the RF amplifier 13.

Then, in the step S204 the control portion 17 detects amplitude of the focus error signal obtained in the above mentioned step S203 and detects a maximum value of the total light quantity signal obtained in the above mentioned step S203.

Next, in the step S205 the control portion 17 sends a control signal to the LD driver for a BD 14, and the LD driver for a BD 14 stops driving of the LD for a BD 10 so that emission of the laser beam from the LD for a BD 10 is stopped. Then, control portion 17 sends a control signal to the LD driver for a CD 16, and the LD driver for a CD 16 activates the LD for a CD 8 so that the LD for a CD 8 emits a laser beam.

Next, in the step S206 the control portion 17 sends a control signal to the liquid crystal driver 12, and the liquid crystal driver 12 applies a predetermined drive voltage for a CD to each of the phase variation regions of the liquid crystal element 5. Thus, spherical aberration is corrected for the laser beam that is emitted from the LD for a CD 8, passes through the aperture 6 and the liquid crystal element 5, and is condensed by the objective lens 3.

Then, in the step S207 the control portion 17 sends the focus drive signal to the actuator driver 11, so that the objective lens 3 moves in the direction of approaching the disc 1. On this occasion, the control portion 17 obtains the focus error signal and the total light quantity signal generated by the RF amplifier 13.

Then, in the step S208 the control portion 17 detects amplitude of the focus error signal obtained in the above mentioned step S207 and detects a maximum value of the total light quantity signal obtained in the above mentioned step S207.

Next, in the step S209 the control portion 17 sends a control signal to the LD driver for a CD 16, and the LD driver for a CD 16 stops driving of the LD for a CD 8 so that emission of the laser beam from the LD for a CD 8 is stopped. Then, control portion 17 sends a control signal to the LD driver for a DVD 15, and the LD driver for a DVD 15 activates the LD for a DVD 9 so that the LD for a DVD 9 emits a laser beam.

Next, in the step S210 the control portion 17 sends a control signal to the liquid crystal driver 12, and the liquid crystal driver 12 applies a predetermined drive voltage for a DVD to each of the phase variation regions of the liquid crystal element 5. Thus, spherical aberration is corrected for the laser beam that is emitted from the LD for a DVD 9, passes through the aperture 6 and the liquid crystal element 5, and is condensed by the objective lens 3.

Then, in the step S211 the control portion 17 sends the focus drive signal to the actuator driver 11, and the objective lens 3 moves in the direction of approaching the disc 1. On this occasion, the control portion 17 obtains the focus error signal and the total light quantity signal generated by the RF amplifier 13.

Then, in the step S212 the control portion 17 detects amplitude of the focus error signal obtained in the above mentioned step S211 and detects a maximum value of the total light quantity signal obtained in the above mentioned step S211.

Next, in the step S213 the control portion 17 calculates a ratio between the amplitude of the focus error signal and the maximum value of the total light quantity signal detected in the above mentioned step S204, a ratio between the amplitude of the focus error signal and the maximum value of the total light quantity signal detected in the above mentioned step S208, and a ratio between the amplitude of the focus error signal and the maximum value of the total light quantity signal detected in the above mentioned step S212. Then, it determines which of a BD, a DVD and a CD the disc 1 is based on comparison among the calculated values. In this way, the disc discrimination operation is completed.

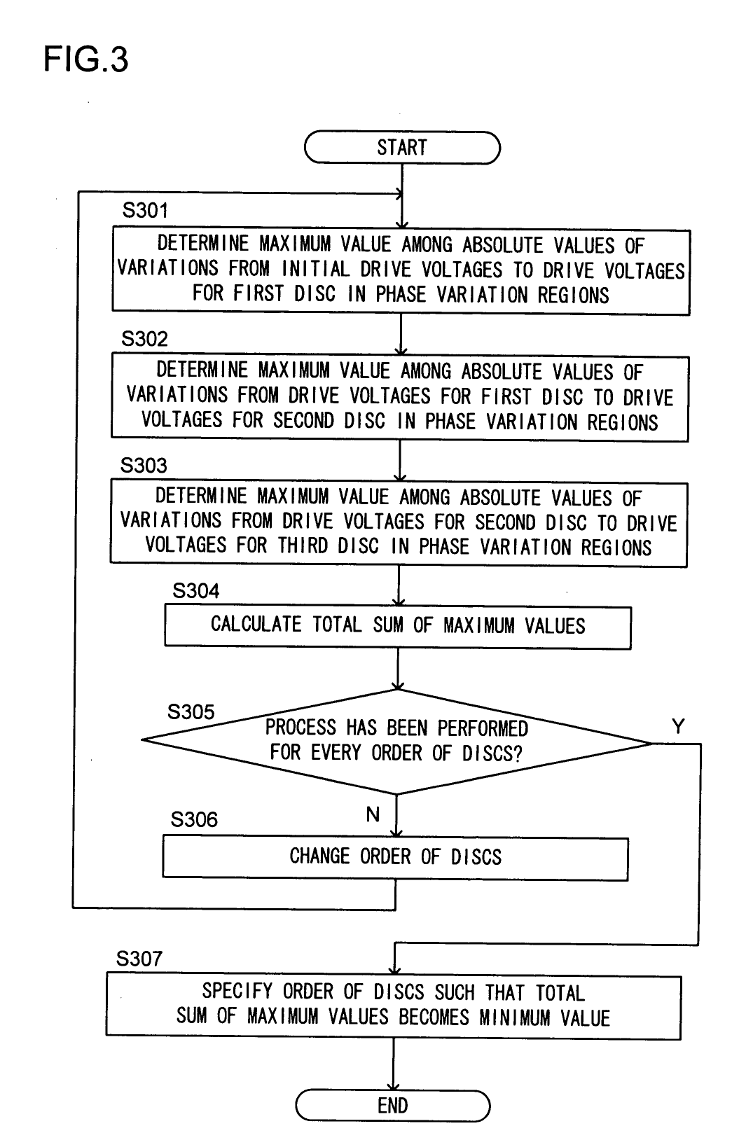

At this point, in the disc discrimination operation described above, emission of the laser beam and driving of the liquid crystal element are performed in the order of a BD, a CD and a DVD. This order is determined by the process flow as shown in FIG. 3 in a stage of designing the disc reproducing apparatus.

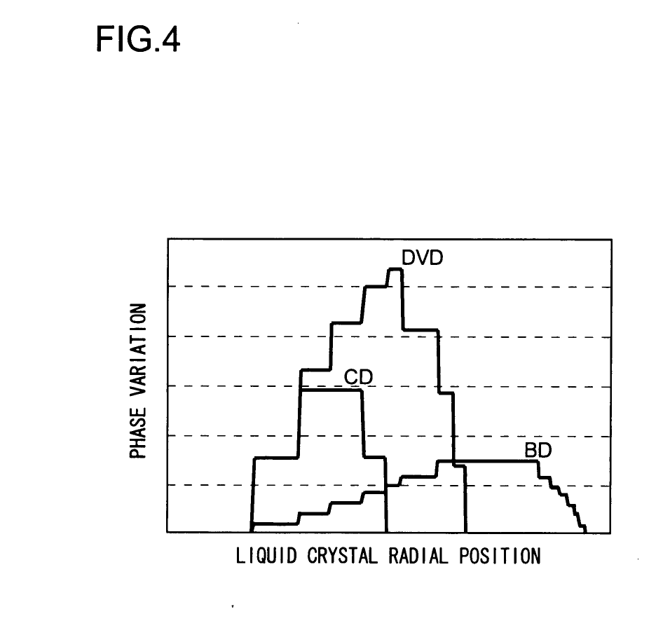

At this point, FIG. 4 shows an example of phase variation for correcting spherical aberration of laser beams for discs that are condensed by the objective lens for each of the phase variation regions of the liquid crystal element. Then, corresponding to such phase variation, a drive voltage is determined for correcting spherical aberration for each of the phase variation regions. In the following description, it is supposed that the drive voltage is predetermined and is stored in a memory or the like for each of phase variation regions with respect to each disc.

First, in the step S301 shown in FIG. 3, a maximum value is determined among absolute values of variations from the initial drive voltages to drive voltages for a first disc (e.g., a BD) in the phase variation regions.

Then, in the step S302, a maximum value is determined among absolute values of variations from the drive voltages for the first disc to drive voltages for a second disc (e.g., a CD) in the phase variation regions.

Then, in the step S303, a maximum value is determined among absolute values of variations from the drive voltages for the second disc to drive voltages for a third disc (e.g., a DVD) in the phase variation regions.

Then, in the step S304, a total sum of the maximum values determined in the above mentioned steps S301-S303 is determined.

Then, in the step S305, it is determined whether or not the above mentioned steps S301-S304 have been performed for every order of discs. If the steps S301-S304 have not been performed yet for every order of discs (N in the step S305), the order of discs is changed (e.g., from the order of a BD, a CD and a DVD to the order of a BD, a DVD and a CD) in the step S306, and the above mentioned steps S301-S304 are performed in the same manner.

Then, in the step S305, if the above mentioned steps S301-S304 have been performed for every order of discs (Y in the step S305), the process flow goes to the step S307. Then, in the step S307, an order of discs such that a total sum of the maximum values determined in the above mentioned step S304 becomes a minimum value is specified with respect to every order of discs.

The disc discrimination operation described above with reference to FIG. 2 is the case where the total sum of the maximum values becomes the minimum value in the order of a BD, a CD and a DVD in the above mentioned step S307, so the laser beams are emitted in the order of the laser beam for a BD, the laser beam for a CD and the laser beam for a DVD, so as to drive the liquid crystal element. At this point, when the liquid crystal element is driven, the drive voltages for phase variation regions that are determined in advance for discs as described above are applied to the phase variation regions.

Thus, response time of the liquid crystal element in the disc discrimination operation can be shortened, thereby operating time of the disc discrimination operation can be shortened.

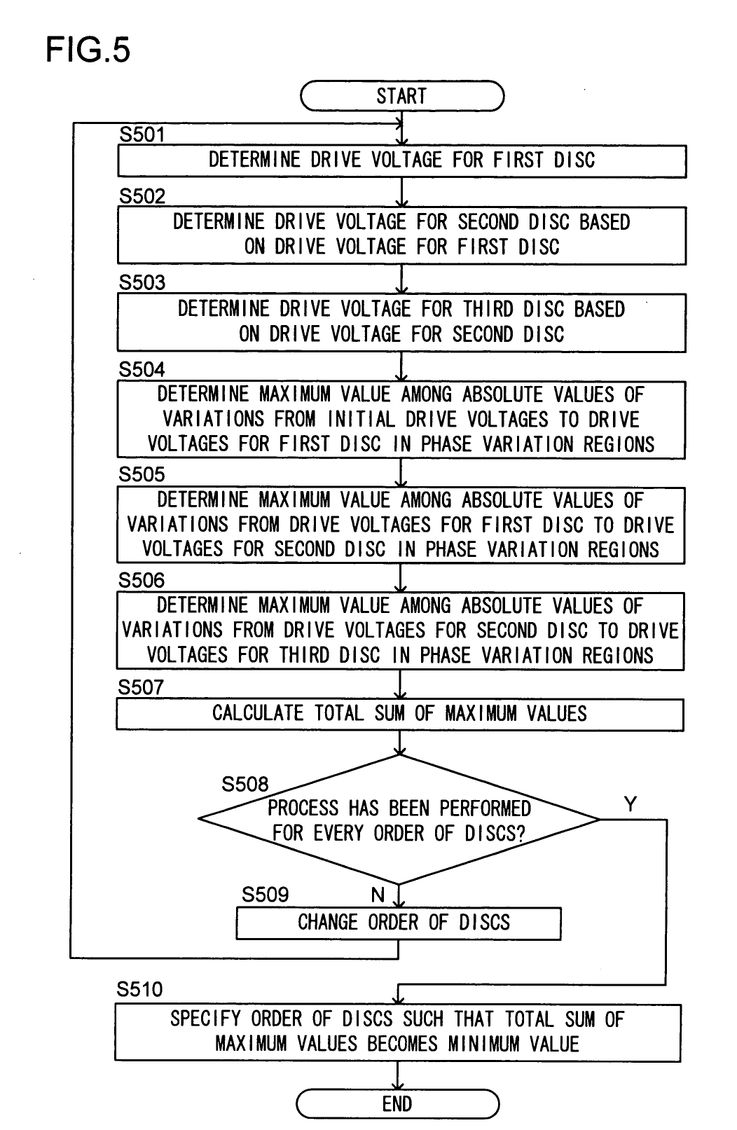

At this point, the order of discs can be determined by the process flow of another embodiment shown in FIG. 5.

First, in the step S501, a drive voltage of the liquid crystal element for a first disc (e.g., a BD) is determined as follows. There is a plurality of phase variations for correcting spherical aberration of the laser beam for the first disc in one phase variation region through which the laser beam for the first disc passes because of periodicity of the laser. For example, if the phase variation for correcting the spherical aberration is 50 degrees, −310 degrees can also be the phase variations for correcting the spherical aberration. Among the drive voltages corresponding to the plurality of phase variations, one having a minimum absolute value of variation from the initial drive voltage is determined to be the drive voltage in the phase variation region. The same process is performed for every phase variation region through which the laser beam for the first disc passes, so that the drive voltages in the phase variation regions in the range where the laser beam passes through are determined. At this point, if the first disc is a CD or a DVD and if there is a phase variation region through which the laser beam for the first disc does not pass, the drive voltage in the phase variation region in the range where the laser beam for the first disc does not pass through is determined to be the same voltage as the initial drive voltage in the phase variation region.

Next, in the step S502, a drive voltage of the liquid crystal element for a second disc (e.g., a CD) is determined as follows. There is a plurality of phase variations for correcting spherical aberration of the laser beam for the second disc in one phase variation region through which the laser beam for the second disc passes because of periodicity of the laser. Among the drive voltages corresponding to the plurality of phase variations, one having a minimum absolute value of variation from the drive voltage for the first disc determined in the above mentioned step S501 is determined to be the drive voltage in the phase variation region. The same process is performed for every phase variation region through which the laser beam for the second disc passes, so that the drive voltages in the phase variation regions in the range where the laser beam passes through are determined. At this point, if the second disc is a CD or a DVD and if there is a phase variation region through which the laser beam for the second disc does not pass, the drive voltage in the phase variation region in the range where the laser beam for the second disc does not pass through is determined to be the same voltage as the drive voltage in the phase variation region for the first disc determined in the above mentioned step S501.

Next, in the step S503, a drive voltage of the liquid crystal element for a third disc (e.g., a DVD) is determined as follows. There is a plurality of phase variations for correcting spherical aberration of the laser beam for the third disc in one phase variation region through which the laser beam for the third disc passes because of periodicity of the laser. Among the drive voltages corresponding to the plurality of phase variations, one having a minimum absolute value of variation from the drive voltage for the second disc determined in the above mentioned step S502 is determined to be the drive voltage in the phase variation region. The same process is performed for every phase variation region through which the laser beam for the third disc passes, so that the drive voltages in the phase variation regions in the range where the laser beam passes through are determined. At this point, if the third disc is a CD or a DVD and if there is a phase variation region through which the laser beam for the third disc does not pass, the drive voltage in the phase variation region in the range where the laser beam for the third disc does not pass through is determined to be the same voltage as the drive voltage in the phase variation region for the second disc determined in the above mentioned step S502.

Next, in the step S504, a maximum value is determined among absolute values of variations from the initial drive voltages to the drive voltages for a first disc determined in the above mentioned step S501 in the phase variation regions.

Then, in the step S505, a maximum value is determined among absolute values of variations from the drive voltages for the first disc determined in the above mentioned step S501 to the drive voltages for the second disc determined in the above mentioned step S502 in the phase variation regions.

Then, in the step S506, a maximum value is determined among absolute values of variations from the drive voltages for the second disc determined in the above mentioned step S502 to the drive voltages for a third disc determined in the above mentioned step S503 in the phase variation regions.

Then, in the step S507, a total sum of the maximum values determined in the above mentioned steps S504-S506 is determined.

Then, in the step S508, it is determined whether or not the above mentioned steps S501-S507 have been performed for every order of discs. If the steps S501-S507 have not been performed yet for every order of discs (N in the step S508), the order of discs is changed (e.g., from the order of a BD, a CD and a DVD to the order of a BD, a DVD and a CD) in the step S509, and the above mentioned steps S501-S507 are performed in the same manner.

Then, in the step S508, if the above mentioned steps S501-S507 have been performed for every order of discs (Y in the step S508), the process flow goes to the step S510. Then, in the step S510, an order of discs such that a total sum of the maximum values determined in the above mentioned step S507 becomes a minimum value is specified with respect to every order of discs.

In the above mentioned step S510, if the total sum of the maximum value becomes the minimum value in the order of a BD, a CD and a DVD for example, the laser beams are emitted in the order of the laser beam for a BD, the laser beam for a CD and the laser beam for a DVD in the disc discrimination operation as described above with reference to FIG. 2 so as to drive the liquid crystal element. At this point, when the liquid crystal element is driven, the drive voltages for phase variation regions for discs determined in the above mentioned steps S501-S503 are applied to the phase variation regions regarding the first disc as a BD, the second disc as a CD and the third disc as a DVD.

Thus, response time of the liquid crystal element in the disc discrimination operation can be shortened further more, so that operating time of the disc discrimination operation can be shortened further more.

What is claimed is:

1. An aberration correcting device comprising:
light sources corresponding to n types (n is a natural number of two or more) of discs;
a light source drive unit that drives the light sources;
a liquid crystal element having a plurality of phase variations regions for correcting spherical aberration;
a liquid crystal driver that drives the liquid crystal element;
an objective lens that condenses a light beam; and
a control unit that applies drive voltages to the phase variation regions sequentially, the drive voltages being for correcting spherical aberration of light beams emitted from the light sources sequentially, by using the light source drive unit and the liquid crystal driver in accordance with phase correction characteristics corresponding to the discs, wherein
in a disc discrimination operation of the aberration correcting device, a total sum of
a maximum value among absolute values of variations from initial drive voltages of the applied drive voltages to drive voltages for correcting spherical aberration of a first light beam in a predetermined order for each of the phase variation regions, and
a maximum value among absolute values of variations from drive voltages for correcting spherical aberration of a k-th light beam to drive voltages for correcting spherical aberration of (k+1)th light beam, the voltages being applied in the predetermined order for each of the phase variation regions when k (k is a natural number that satisfies n−1≧k≧1) is changed from 1 to n−1 in turn,
is a minimum value among the total sums that are determined in the same manner for every order of emitting light from the light sources.

2. The aberration correcting device according to claim 1, wherein
each of the drive voltages for correcting spherical aberration of the first light beam is a drive voltages having a minimum absolute value of variation from the initial drive voltage among a plurality of drive voltages for correcting the spherical aberration that exist because of periodicity of the light beam, and
each of the drive voltages for correcting spherical aberration of the (k+1)th light beam is a drive voltages having a minimum absolute value of variation from the k-th drive voltage among the plurality of drive voltages.

3. A disc apparatus equipped with the aberration correcting device according to claim 1.

4. A program for a control portion of an aberration correcting device to perform a disc discrimination operation, the aberration correcting device including
light sources corresponding to n types (n is a natural number of two or more) of discs,
a light source drive unit that drives the light sources,
a liquid crystal element having a plurality of phase variations regions for correcting spherical aberration,
a liquid crystal driver that drives the liquid crystal element,
an objective lens that condenses a light beam, and
a control unit that applies drive voltages to the phase variation regions sequentially, the drive voltages being for correcting spherical aberration of light beams emitted from the light sources sequentially, by using the light source drive unit and the liquid crystal driver in accordance with phase correction characteristics corresponding to the discs, wherein a total sum of
a maximum value among absolute values of variations from initial drive voltages of the applied drive voltages to drive voltages for correcting spherical aberration of a first light beam in a predetermined order for each of the phase variation regions, and
a maximum value among absolute values of variations from drive voltages for correcting spherical aberration of a k-th light beam to drive voltages for correcting spherical aberration of (k+1)th light beam, the voltages being applied in the predetermined order for each of the phase variation regions when k (k is a natural number that satisfies n−1≧k≧1) is changed from 1 to n−1 in turn,
is a minimum value among the total sums that are determined in the same manner for every order of emitting light from the light sources.
